(19) United States
(12) Patent Application Publication
(10) Pub. No.: US 2025/0360658 A1
(43) Pub. Date: Nov. 27, 2025

(54) MOLDING DIE, INJECTION MOLDING APPARATUS, AND METHOD FOR PRODUCING RESIN MOLDED PRODUCT

(71) Applicant: CANON KABUSHIKI KAISHA, Tokyo (JP)

(72) Inventor: TAKAMICHI OCHIAI, Ibaraki (JP)

(21) Appl. No.: 19/186,833

(22) Filed: Apr. 23, 2025

(30) Foreign Application Priority Data
May 23, 2024 (JP) 2024-084071

(51) Int. Cl. B29C 33/42; B29C 33/38; B29C 45/27

(52) U.S. Cl. CPC B29C 33/42; B29C 33/38; B29C 45/27

(57) ABSTRACT

A molding die includes a first die having a first molding surface, and a second die having a second molding surface and a runner surface connected to the second molding surface by a connection portion. In a state in which the first die and the second die are clamped, a runner is defined by the runner surface, and a cavity is defined by the first molding surface and the second molding surface. A material of at least a part of the first die and the second die contains any one of a resin, a ceramic, and glass as a main component. A relationship of T (mm)<Dm (mm) is satisfied, in which T (mm) represents a shortest distance between the connection portion and the first molding surface, and Dm (mm) represents an inner diameter of the connection portion.

### BACKGROUND

### Field of the Technology

The present disclosure relates to a molding die, an injection molding apparatus, a method for producing a resin molded product, and the like.

### Description of the Related Art

In injection molding, a resin molded product is generally produced by injecting a molten resin at a high temperature of 200 to 300° C. into a cavity of a molding die, but since it is necessary to fill the cavity with the resin at a high speed and a high pressure, a metallic material having a sufficient strength is often used for the molding die. Generally, a molding die formed of metal, that is, a mold, tends to have a large weight.

Under the situation where products are diversified as in recent years, for example, it may be necessary to produce various types of resin molded products in a small lot with a daily production number of about 100 or less. In such a case, it is necessary to replace a mold of an injection molding machine each time the type of the resin molded product to be produced changes.

However, for example, metal such as SUS is not easy to process, and thus it may take a long time to manufacture the mold with metal. In addition, since metal molds are heavy, there is a problem that a work load and a work time of mold replacement work (so-called set-up change) increase and production efficiency decreases in the case of producing various types in small lots.

JP 2018-130935 describes a method for producing a gear formed of a resin by injection molding using a molding die formed of a resin. The molding die formed of a resin can be relatively easily manufactured by, for example, 3D printing or machining, and has an advantage that the molding die can be manufactured more quickly than a metal mold.

Since a resin is a material lighter than metal, there is a possibility that the molding die can be reduced in weight. However, since a strength of the material is not necessarily higher than that of metal, there may be a problem that cracking or plastic deformation is likely to occur when a high-temperature molten resin is injected into the cavity. In particular, such damage is likely to occur at a portion where the molten resin injected from a gate into the cavity collides first in the cavity. In a case where durability of the molding die is low, it is necessary to frequently replace the molding die with a new molding die in order to secure shape accuracy of the resin molded product, as a result of which productivity of the resin molded product may be lowered.

Therefore, there has been a demand for a molding die using a material different from metal and having more excellent durability than a resin molding die according to the related art.

### SUMMARY OF THE INVENTION

According to a first aspect of the present disclosure, a molding die includes a first die having a first molding surface, and a second die having a second molding surface and a runner surface connected to the second molding surface by a connection portion. In a state in which the first die and the second die are clamped, a runner is defined by the runner surface, and a cavity is defined by the first molding surface and the second molding surface. A material of at least a part of the first die and the second die contains any one of a resin, a ceramic, and glass as a main component. A relationship of T (mm)<Dm (mm) is satisfied, in which T (mm) represents a shortest distance between the connection portion and the first molding surface, and Dm (mm) represents an inner diameter of the connection portion.

According to a second aspect of the present disclosure, a molding die includes a first die having a first molding surface, and a second die having a second molding surface and a runner surface connected to the second molding surface by a connection portion. 50 vol % or more of the molding die is formed of a material containing a polyimide resin as a main component.

Further features of the present disclosure will become apparent from the following description of exemplary embodiments with reference to the attached drawings.

### BRIEF DESCRIPTION OF THE DRAWINGS

FIG. 1 is a schematic cross-sectional view of an injection molding apparatus according to an embodiment.

FIG. 2A is an external view of a runner-attached molded product molded by the injection molding apparatus according to the embodiment when viewed obliquely from above.

FIG. 2B is an external view of the runner-attached molded product when viewed obliquely from below.

FIG. 3 is a cross-sectional view of the runner-attached molded product taken along a line passing through a runner solidified material.

FIG. 4A is an external view of a modified example of the runner-attached molded product molded by the injection molding apparatus according to the embodiment when viewed obliquely from above.

FIG. 4B is a cross-sectional view of the runner-attached molded product according to the modified example taken along a line passing through the runner solidified material.

### DESCRIPTION OF THE EMBODIMENTS

A molding die, an injection molding apparatus, a method for producing a resin molded product, and the like according to embodiments of the present disclosure will be described with reference to the drawings. The embodiments described below are merely examples, and for example, detailed configurations can be appropriately changed and implemented by those skilled in the art without departing from the gist of the present disclosure.

In the drawings referred to in the following description of the embodiments and examples, elements denoted by the same reference signs have the same functions unless otherwise specified. In the drawings, in a case where a plurality of the same elements are arranged, reference signs and a description thereof may be omitted.

In addition, the drawings may be schematic for convenience of illustration and description, and thus, the shape, size, arrangement, and the like of elements in the drawings may not strictly match those of actual ones. In addition, “XX or more and YY or less” or “XX to YY” representing a numerical range means a numerical range including end points XX (lower limit) and YY (upper limit) unless otherwise specified. When numerical ranges are described in stages, the upper limit and the lower limit of each numerical range can be arbitrarily combined.

### Outline of Embodiment

In an embodiment described below, a portion formed of a material containing any one of a resin, a ceramic, and glass as a main component is provided in at least a part of a molding die. The main component herein is a component having the largest weight when there are a plurality of components (materials) contained in the portion, and in the present specification, the largest weight means that the component occupies 50 wt % or more.

The molding die may include a first die and a second die, and the first die and the second die can be clamped. One (for example, the first die) of the first die and the second die may be a movable die and the other (for example, the second die) may be a fixed die. In addition, at least a part of each of the first die and the second die included in the molding die includes a molding piece having a molding surface and defining a cavity when the dies are clamped. Among surfaces of the molding piece, a surface serving as an inner wall of the cavity is the molding surface. At least one of the first die and the second die included in the molding die may include a plurality of molding pieces. A portion formed of a material containing any one of a resin, a ceramic, and glass as a main component may be provided in at least one of the plurality of molding pieces. The molding piece in the second die may include a runner that is a flow path for injecting a molten resin into the cavity, and a gate which is a connection portion between the runner and the cavity. The molten resin injected into the runner is injected into the cavity through the gate. In the molding die (molding piece), a surface defining the cavity is referred to as the molding surface, and a surface defining the runner is referred to as a runner surface. In the gate which is the connection portion between the runner and the cavity, the runner surface and the molding surface are connected by a connection portion. The gate can be a portion surrounded by the connection portion between the runner surface and the molding surface. The molding die includes a portion facing the gate which is the connection portion between the runner and the cavity, and a portion facing the connection portion between the runner surface and the molding surface. The portion facing the connection portion between the runner surface and the molding surface surrounds the portion facing the gate which is the connection portion between the runner and the cavity. In the molding die, the portion facing the connection portion between the runner surface and the molding surface and the portion facing the gate which is the connection portion between the runner and the cavity are referred to as facing portions. The facing portion in the molding die includes a part of the molding surface and the vicinity thereof (the inside of the molding die). In the facing portion in the molding die, the part of the molding surface is referred to as a facing region. The runner may be a cold runner or a hot runner, but the present embodiment is suitable for a case where a cold runner is adopted. In a case where a hot runner is adopted, a valve pin that closes the gate can be disposed in the runner.

The molding die using the material containing any one of a resin, a ceramic, and glass as the main component can be manufactured by processing techniques such as cutting, polishing, molding with a die, forming with a 3D printer, and coating. As the resin, a polyimide resin, an epoxy resin, an acrylic resin, a silicone resin, a fluororesin, or the like can be used. A molding die in which 50 vol % or more is formed of the resin is referred to as a resin die. As the ceramic, silicon oxide, aluminum oxide, zirconium oxide, silicon nitride, aluminum nitride, silicon carbide, or the like can be used. A molding die in which 50 vol % or more is formed of the ceramic is referred to as a ceramic die. As the glass, silicate glass, borosilicate glass, quartz glass, soda lime glass, lead glass, or the like can be used. A molding die in which 50 vol % or more is formed of the glass is referred to as a glass die. For the sake of simplicity, a material containing any one of the resin, the ceramic, and the glass as a main component is referred to as a non-metallic material.

In an embodiment, at least a part of a molding die is formed using a low-density material which is a material containing any one of the resin, the ceramic, and the glass as a main component and has a density of lower than 5.0 (g/cm³) to implement a molding die lighter than a metal molding die. SUS generally used as a metallic material for a molding die hitherto has a density of about 7.9 (g/cm³). The metallic material for a molding die is not limited to SUS, and it can be said that metal used for the molding die is a material having a relatively high density. In order to reduce a weight of the molding die as compared with such a molding die (mold) using metal according to the related art, a low-density material can be used. In order to reduce the weight of the molding die, a volume of the low-density material in the molding die is preferably 25 vol % or more, more preferably 50 vol % or more, and may be 75 vol % or more. In an embodiment, a material containing any one of the resin, the ceramic, and the glass as a main component and having a density of 3.5 (g/cm³) or less, and a material having a density of 3.0 (g/cm³) or less can also be used.

In an embodiment, in order for the molding die using a material containing any one of the resin, the ceramic, and the glass as a main component to have necessary durability, the molding die is formed such that a shape of the runner and a shape of the cavity satisfy a predetermined relationship. The molding die is formed such that a relationship of T (mm)<Dm (mm) is satisfied, in which T (mm) represents the shortest distance between the gate which is the connection portion between the runner and the cavity and the portion (facing portion) of the molding die that faces the gate, and Dm (mm) represents an inner diameter of the gate. A ratio Dm/T of Dm (mm) to the distance T (mm) is preferably 1.1 or more, and may be 1.5 or more, 2.0 or more, 4.0 or less, or 3.0 or less.

In the molding die, a portion that is likely to be damaged is a portion where the molten resin injected into the cavity through the gate directly collides with the molding die. That is, the facing portion of the molding die that faces the gate is likely to be damaged. When a flow speed of the colliding molten resin is high, cracks and plastic deformation occur in the facing portion, and the durability in practical use is deteriorated. In the present embodiment, in the molding die formed of the material containing any one of the resin, the ceramic, and the glass as the main component, a speed of the molten resin colliding with the portion that is likely to be damaged is reduced to improve the durability of the molding die. It will be understood that, for example, when spraying water with a hose, if an outlet diameter of the hose is decreased, an initial speed of the water splashing out of the hose is increased, and if the outlet diameter is increased, the initial speed of the water splashing out is decreased. In the embodiment, as the molding die is formed such that a relationship of T (mm)<Dm (mm) is satisfied, an opening diameter of the gate can be sufficiently increased, so that a speed at which the molten resin injected through the gate collides with the molding surface facing the gate across a space of the cavity can be reduced.

The above-mentioned dimensional relationship is preferable when the portion that is likely to be damaged is formed of the material containing any one of the resin, the ceramic, and the glass as the main component, which is a material that is more likely to be damaged as compared with metal. In particular, it is preferable when the portion formed of the material containing any one of the resin, the ceramic, and the glass as the main component is included in a range of a distance D (mm) equal to Dm (mm) or less from the connection portion. A range of the distance T (mm) from the connection portion is the facing region. The range of the distance D (mm) or less from the connection portion is a range of (D-T) (mm) from the facing region to the inside of the molding die. If the facing region is formed of the material containing any one of the resin, the ceramic, and the glass as the main component, a portion at the distance T (mm) from the connection portion is formed of the material containing any one of the resin, the ceramic, and the glass as the main component. The facing region which is the molding surface in the facing portion may be formed of the non-metallic material, and the metallic material may be used as a base thereof. Alternatively, the facing region which is the molding surface in the facing portion may be formed of the metallic material, and the non-metallic material may be used as the base thereof. The metallic material provided on the molding surface in this case can function as a protective layer. The facing region may be formed of the metallic material, the base thereof may be formed of the non-metallic material, and the base thereof may be formed of the metallic material. In any case, damage to the non-metallic material within the range of the distance D (mm) or less from the connection portion is suppressed.

In an embodiment, the runner and the cavity are formed such that a relationship of T (mm)<Dmin (mm) is satisfied, in which Dmin (mm) represents a minimum diameter of the runner. When the relationship of T (mm)<Dmin (mm) is satisfied, the gate diameter Dm can be made larger than the minimum diameter Dmim, so that the speed of the molten resin colliding with the portion (facing portion) that is likely to be damaged can be further reduced. In a case where the runner is a cold runner, a pipe wall (runner surface) of the runner can be formed as a slope tapered such that a diameter decreases from the gate toward an injection unit in order to smoothly release a runner solidified material solidified in the runner when releasing the resin molded product.

SUS generally used as the metallic material of the molding die hitherto has a thermal conductivity of about 16 (W/mK) to 26 (W/mK). The metallic material of the molding die is not limited to SUS, and it can be said that metal used for the molding die is a material having a relatively high thermal conductivity. As described above, in a case where the thermal conductivity of the molding die is high, a part of the molten resin flowing in the cavity and the runner is easily cooled and solidified, and easily adheres to the inner wall (molding surface) of the cavity and an inner wall (runner surface) of the runner. Then, before the filling of the cavity with the molten resin is completed, an effective flow path cross-sectional area of the cavity or the runner decreases, and it becomes difficult to fill the cavity with the resin without gaps. In a case where a thermal conductivity of the vicinity of the molding surface is high, the molten resin is easily cooled on the inner wall (molding surface) of the cavity, a surface layer (skin layer) is formed on a molded body, and characteristics of the molded body are also affected. In an injection molding apparatus including the metal molding die according to the related art, an injection pressure from an injection unit is increased to fill a cavity with a molten resin without any gap. However, in a case where the injection pressure of the molten resin is increased, the molten resin collides with a portion facing an injection gate across a space of the cavity in a molding surface forming the cavity, particularly in a movable side molding die, at a high pressure and a high speed. Then, such a portion of the molding die tends to be locally damaged, and practical durability of the molding die is deteriorated.

In an embodiment, at least a part of the molding die is formed using a low thermal conductivity material which is a material containing any one of the resin, the ceramic, and the glass as the main component and having a thermal conductivity of lower than 10 (W/mK). In an embodiment, a material containing any one of the resin, the ceramic, and the glass as the main component and having a thermal conductivity of 5.0 (W/mK) or lower, and a material having a thermal conductivity of 4.0 (W/mK) or lower can also be used. In an embodiment, the low thermal conductivity material having a relatively lower thermal conductivity than the metallic material is used. Specifically, as the molding die is formed using a material having a thermal conductivity of lower than 10 (W/mK), excessive cooling of the molten resin during injection in the cavity or the runner is suppressed. As a result, it is possible to suppress an excessive decrease in the effective flow path cross-sectional area in the runner until the filling of the cavity is completed, and it is not necessary to perform injection at a high pressure. Therefore, the portion facing the injection gate is less likely to be damaged. In addition, since molding can be performed at a lower injection pressure as compared with the metal molding die (mold) in which a resin is easily solidified on a wall surface of the runner, the injection molding apparatus can be implemented using a relatively small injection unit.

In a state in which the first die and the second die are clamped, a portion within the distance D (mm) equal to Dm (mm) from the connection portion is preferably formed of the low thermal conductivity material in the first die. Therefore, it is possible to suppress rapid cooling of the molten resin injected into the cavity at the facing portion. In particular, it is preferable that the facing region facing the connection portion in the molding surface of the first die is formed of the low thermal conductivity material. In the first die, a portion within 1 (mm) from a region facing the molding surface of the second die via the cavity in the molding surface of the first die is preferably formed of the low thermal conductivity material. In the second die, it is also preferable that a portion within 1 (mm) from a region facing the molding surface of the first die via the cavity in the molding surface of the second die is formed of the low thermal conductivity material. Therefore, the generation of the skin layer in the cavity can be suppressed. In the second die, a portion within 1 mm from the runner surface is preferably formed of the low thermal conductivity material. As a result, it is possible to suppress solidification of the molten resin in the runner. The low thermal conductivity material provided within 1 mm from the molding surface or the runner surface is useful for implementing the molding die including heat insulating layers. The protective layer such as the metallic material may be formed on the heat insulating layers, and the protective layer may form the molding surface. For the heat insulating layer, JP H09-155876 A, JP H09-239737 A, JP 2001-334534 A, and JP 2002-321246 A can be referred to.

In an embodiment, the molding die using the material containing any one of the resin, the ceramic, and the glass as the main component can be formed such that a relationship of Vc (mm³)<Vr (mm³) is satisfied, in which Vc (mm³) represents a volume of the cavity and Vr (mm³) represents a volume of the runner. Hitherto, the volume of the runner is made as small as possible in order to reduce a volume of the runner solidified material, but in the case of the molding die manufactured using the above-described material without using metal, it is desirable to form the molding die as described above in order to obtain practical durability. A total volume Vn (mm³) of the non-metallic material used in the molding die is preferably larger than the sum of the volume Vc (mm³) of the cavity and the volume Vr (mm³) of the runner. In a preferred example, the total volume Vn (mm³) of the non-metallic material is larger than a total volume Vm (mm³) of the metallic material used in the molding die.

Since the molding die according to an embodiment is lighter than the metal molding die (mold), it is easy to attach and detach the molding die to and from the injection molding apparatus (or an injection molding system), and for example, it is possible to easily perform set-up change when small-lot production is performed. The molding die according to the embodiment can have sufficient practical durability as necessary while using the material containing any one of the resin, the ceramic, and the glass as the main component. In order to further enhance the durability, a thickness of the non-metallic material in the vicinity of the molding surface or the runner surface in a direction perpendicular to the molding surface or the runner surface is preferably 10 mm or more.

### Embodiment

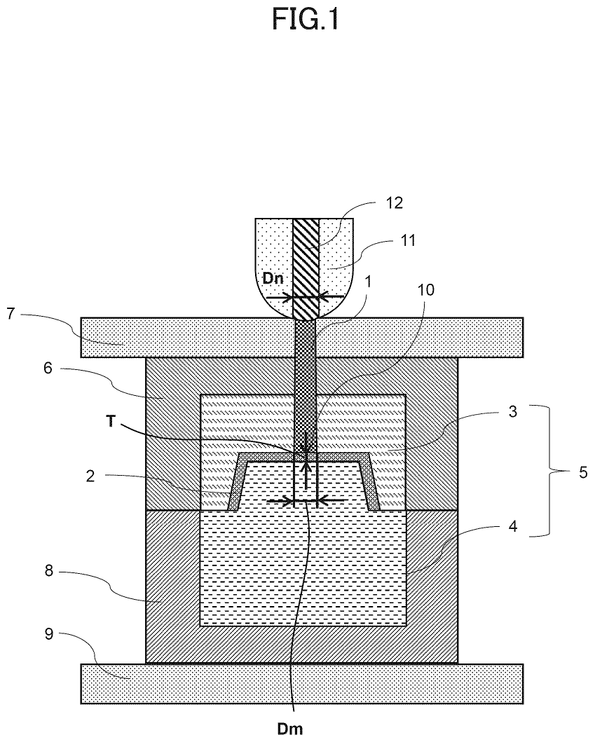

An outline of a molding die and an injection molding apparatus according to an embodiment will be described with reference to FIG. 1. FIG. 1 is a schematic cross-sectional view of the injection molding apparatus and illustrates a clamped state. In the clamped state, a cavity 2 for molding a resin molded product is defined by a fixed piece 3 (second die) and a movable piece 4 (first die).

The fixed piece 3 (second die) and the movable piece 4 (first die) are formed of a material containing any one of a resin, a ceramic, and glass as a main component. The fixed piece 3 and the movable piece 4 may be, for example, three-dimensional objects manufactured by 3D printing, or may be manufactured by processing a base material by a machining technique such as cutting, drilling, or polishing. The fixed piece 3 and the movable piece 4 may be collectively referred to as a molding die 5.

The fixed piece 3 is attached to a fixed-side die plate 6 (support member), and the fixed-side die plate 6 is fixed to a fixed-side attachment plate 7. The fixed-side die plate 6 and the fixed-side attachment plate 7 are members requiring a sufficiently high mechanical strength, and may be formed of metal or may be formed of a material other than metal. A unit in which the fixed piece 3, the fixed-side die plate 6, and the fixed-side attachment plate 7 are integrated may be referred to as a fixed die. In a case where the fixed piece 3 has a sufficient mechanical strength, the fixed piece 3 may be directly fixed to the fixed-side attachment plate 7 without providing the fixed-side die plate 6 (support member).

The movable piece 4 is attached to a movable-side die plate 8 (support member), and the movable-side die plate 8 is fixed to a movable-side attachment plate 9. The movable-side die plate 8 and the movable-side attachment plate 9 are members requiring a sufficiently high mechanical strength, and may be formed of metal or may be formed of a material other than metal. The movable piece 4, the movable-side die plate 8, and the movable-side attachment plate 9 are configured to be integrally movable, and can move in an upward direction in the figure at the time of clamping and can move in a downward direction in the figure at the time of mold opening. A unit in which the movable piece 4, the movable-side die plate 8, and the movable-side attachment plate 9 are integrated may be referred to as a movable die. In a case where the movable piece 4 has a sufficient mechanical strength, the movable piece 4 may be directly fixed to the movable-side attachment plate 9 without providing the movable-side die plate 8 (support member).

A cold runner 1 which is a flow path of a molten resin is provided in the fixed piece 3, the fixed-side die plate 6, and the fixed-side attachment plate 7. A lower end of the cold runner 1 is connected to the cavity 2 via a gate 10, and an upper end of the cold runner 1 is connected to an injection unit 11 via an opening provided in the fixed-side attachment plate 7. That is, the cold runner 1 is a pipeline that communicates from the injection unit 11 to the cavity 2 and serves as the flow path of the molten resin injected from the injection unit 11.

Unlike a so-called hot runner, the cold runner 1 is not provided with a heater for heating the pipeline, and the molten resin remaining in the cold runner 1 when the cavity 2 is filled with the molten resin is cooled and solidified together with the molten resin filling the cavity. The resin molded product obtained by solidifying the molten resin injected into the cavity 2 and a runner solidified material solidified in the cold runner 1 are taken out from the molding die as a connected integral solidified material. In the following description, for convenience, the integrated material in which the resin molded product and the runner solidified material are connected to each other may be referred to as a runner-attached molded product.

In FIG. 1, an inner diameter of the gate 10 which is a connection portion between the cold runner 1 and the cavity 2 is Dm (mm). In addition, a distance between a molding surface of the movable piece 4 that faces the gate 10 across the cavity 2 and the gate 10 is T (mm). In the embodiment, as the molding die is formed such that a relationship of T (mm)<Dm (mm) is satisfied, an opening diameter of the gate can be sufficiently increased, so that a speed at which the molten resin injected through the gate collides with the molding surface facing the gate across a space of the cavity is reduced. As a preferred example, a condition of T (mm)≥0.5 (mm) may be satisfied. As a preferred example, either condition of T (mm)<10 (mm), T (mm)<5 (mm), and T (mm)≤3 (mm) may be satisfied. As a preferred example, either condition of Dm (mm)≥1 (mm), Dm (mm)≤10 (mm), and Dm (mm)≤5 (mm) may be satisfied.

It is desirable that a relationship of Dm (mm)<Dn (mm) is satisfied, in which Dn (mm) represents a diameter (nozzle diameter) of a resin flow path 12 of the injection unit 11. Therefore, it is desirable that a relationship of T (mm)<Dm (mm)<Dn (mm) is satisfied. As a preferred example, conditions of Dn (mm)>5 (mm) and Dm (mm)≤5 (mm) may be satisfied.

In the example of FIG. 1, one cold runner 1 (and gate 10) is provided for one cavity 2, but a plurality of cold runners 1 (and gates 10) may be provided for one cavity 2. Even in this case, as the molding die is formed such that the relationship of T (mm)<Dm (mm) is satisfied for each gate, a speed at which the molten resin injected through each gate collides with the molding surface facing the gate across the space of the cavity is reduced.

The gate of the runner according to the present embodiment adopts a configuration suitable for satisfying the relationship of T (mm)<Dm (mm), and a flow path diameter of the connection portion between the runner and the cavity does not have to be reduced like a so-called pin gate. In addition, it is not necessary to connect a gate having a small flow path diameter to a side surface of the cavity like a so-called side gate.

In order to facilitate understanding of the configuration of the runner and the cavity in the injection molding apparatus according to the embodiment, the runner-attached molded product taken out from the molding die after molding will be described by way of example. As described above, the runner-attached molded product refers to a product taken out as an integrated product in which the resin molded product and the runner solidified material are connected to each other.

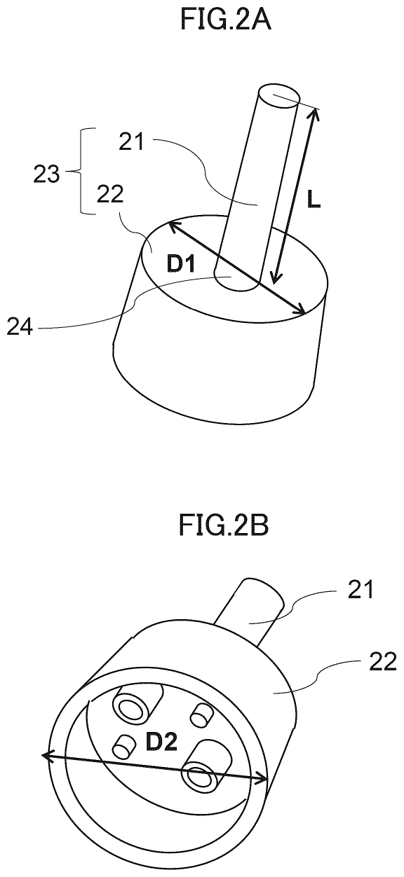

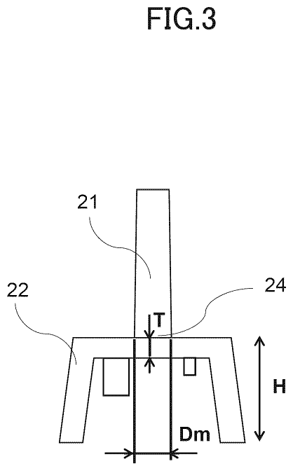

FIG. 2A is an external view of a runner-attached molded product 23 when viewed obliquely from above, and FIG. 2B is an external view of the runner-attached molded product 23 when viewed obliquely from below. FIG. 3 is a cross-sectional view of the runner-attached molded product 23 taken along a line passing through the runner solidified material.

The runner-attached molded product 23 is a resin molded product in which a resin molded product 22 and a runner solidified material 21 are integrated. Although the runner solidified material 21 is removed from the runner-attached molded product 23 taken out from the injection molding apparatus in a subsequent step, the runner-attached molded product 23 to which the runner solidified material 21 remains attached may be used as a product depending on application of the resin molded product 22. Although the figures illustrate a state in which the runner solidified material is not removed, a gate mark 24 which is a trace of the gate 10 at the time of molding can remain in the resin molded product 22 even in a case where the runner solidified material 21 is removed.

A length L of the runner solidified material corresponds to a flow path length of the cold runner 1 at the time of molding. A thickness T (FIG. 3) of the resin molded product 22 at a portion of the gate mark 24 corresponds to a distance T (FIG. 1) between the gate 10 and the molding surface of the movable piece 4 that faces the gate 10. Dm (FIG. 3), which is a diameter of the gate mark 24, corresponds to Dm (FIG. 1), which is the inner diameter of the gate 10 at the time of molding.

In the example of the molded product 23 illustrated in the figure, dimensions are configured as L=28 (mm), D1=34 (mm), D2=35 (mm), T=1.8 (mm), and H=12 (mm).

### EXAMPLES AND COMPARATIVE EXAMPLES

Examples in which molded products having such a shape were manufactured using different molding dies are shown below as Examples and Comparative Examples. Common molding conditions in Examples and Comparative Examples are shown in Table 1.

TABLE 1

| | |
|---|---|
| Resin | Polyacetal |

| | | |
|---|---|---|
| Nozzle Temperature of Injection Unit | 200° | C. |
| Die Surface Temperature | 150° | C. |
| (At Time of Injection) | | |

| | |
|---|---|
| Die Temperature | Room Temperature |
| | (No Cooling Circuit) |

| | | |
|---|---|---|
| Injection Speed | 10 | mm/s |
| Molding Cycle | 600 | s |

Next, Examples and Comparative Examples will be specifically described. In all Examples and Comparative Examples, a fixed piece and a movable piece were manufactured by cutting a lump of a base material formed of a material specified by a “material name”. A runner surface and a molding surface of the fixed piece and a molding surface of the movable piece are formed of the material indicated by the “material name”, and a thickness of these materials from the runner surface or the molding surface is 10 mm or more. 50 vol % or more of the molding die is formed of the material indicated by the “material name”.

As for the material used for the molding die exemplified below, a high-temperature tensile strength refers to a maximum strength that the material used for the molding die can withstand in a case where a tensile stress is applied to the material used for the molding die under a test temperature environment. When the molding die is put into practical use, the high-temperature tensile strength can be an index of whether or not the die is easily damaged irreversibly by plastic deformation. In Examples, for example, a material having a high-temperature tensile strength of 31 MPa or more at 100° C. is suitably used. In Examples, for example, a material having a high-temperature tensile strength of 270 MPa or less at 100° C. is suitably used.

In addition, a thermal deformation temperature refers to a temperature at which a magnitude of deflection becomes a certain value when raising the temperature in a state in which a predetermined load is applied to the material used for the molding die, and a test method is defined in, for example, JIS7191. When performing injection molding, the thermal deformation temperature can be an index of whether or not the molding surface of the die is deformed and shape accuracy of the resin molded product is likely to decrease. In Examples, for example, a material having a thermal deformation temperature of 150° C. or higher is suitably used. In Examples, for example, a material having a thermal deformation temperature of 500° C. or lower is suitably used.

In Examples, for example, a material having a density of 3.0 g/cm³ or less is suitably used. In Examples, a material having a thermal conductivity of 5.0 W/mK or less is suitably used.

### Example 1

Table 2 shows material physical properties of the fixed piece 3 and the movable piece 4 in Example 1, the gate diameter Dm of the gate 10 illustrated in FIG. 1, and a ratio Dm/T of Dm to the distance T.

TABLE 2

| Material Physical | Material Name | Polyimide | |
|---|---|---|---|
| Properties of | Thermal Conductivity | 0.4 | W/mK |
| Fixed Piece 3 and | Density | 1.4 | g/cm³ |
| Movable Piece 4 | High-Temperature Tensile | 41 MPa | |
| | Strength (At 260° C.) | (116 MPa at Room | |
| | | Temperature) | |
| | Thermal Deformation | 360° | C. |
| | Temperature | | |

| | | |
|---|---|---|
| Volume of Molding Die | 500 | cm³ |
| Gate Diameter Dm of Cold Runner | Φ2.7 | mm |

| | |
|---|---|
| Ratio Dm/T of Gate Diameter Dm to Distance T | 1.5 |

When injection molding was performed using a molding die using polyimide shown in Table 2, a pressure loss in a portion of the cold runner 1 was 4.9 MPa, and a pressure loss in a portion of the cavity 2 was 2.9 MPa. A total pressure loss was 7.8 MPa, which was sufficiently low with respect to the high-temperature tensile strength, and therefore die breakage due to plastic deformation did not occur. In addition, die breakage due to thermal deformation of the polyimide was not observed.

### Example 2

Table 3 shows material physical properties of the fixed piece 3 and the movable piece 4 in Example 2, the gate diameter Dm of the gate 10 illustrated in FIG. 1, and the ratio Dm/T of Dm to the distance T.

TABLE 3

| Material Physical | Material Name | Chemical Wood | |
|---|---|---|---|
| Properties of | Thermal Conductivity | 0.3 | W/mK |
| Fixed Piece 3 and | Density | 1.2 | g/cm³ |
| Movable Piece 4 | High-Temperature Tensile | 31 MPa | |
| | Strength (At 100° C.) | (50 MPa at Room | |
| | | Temperature) | |
| | Thermal Deformation | 190° | C. |
| | Temperature | | |

| | | |
|---|---|---|
| Volume of Molding Die | 500 | cm³ |

| | |
|---|---|
| Gate Diameter Dm of Cold Runner | Φ5 |
| Ratio Dm/T of Gate Diameter Dm to Distance T | 2.8 |

When injection molding was performed using a molding die using a chemical wood shown in Table 3, a pressure loss in the portion of the cold runner 1 was 0.5 MPa, and a pressure loss in the portion of the cavity 2 was 1.2 MPa. A total pressure loss was 1.7 MPa, which was sufficiently low with respect to the high-temperature tensile strength, and therefore die breakage due to plastic deformation did not occur. In addition, die breakage due to thermal deformation of the chemical wood was not observed. The chemical wood is a material in which an inorganic filler is added to a urethane or epoxy resin as a main component to artificially impart a wood-like property.

### Example 3

Table 4 shows material physical properties of the fixed piece 3 and the movable piece 4 in Example 3, the gate diameter Dm of the gate 10 illustrated in FIG. 1, and the ratio Dm/T of Dm to the distance T.

TABLE 4

| Material Physical | Material Name | Epoxy Resin | |
|---|---|---|---|
| Properties of | Thermal Conductivity | 0.3 | W/mK |
| Fixed Piece 3 and | Density | 1.1 | g/cm³ |
| Movable Piece 4 | High-Temperature Tensile | 27 MPa | |
| | Strength (At 140° C.) | (89 MPa at Room | |
| | | Temperature) | |
| | Thermal Deformation | 260° | C. |
| | Temperature | | |

| | | |
|---|---|---|
| Volume of Molding Die | 500 | cm³ |

| | |
|---|---|
| Gate Diameter Dm of Cold Runner | Φ3 |
| Ratio Dm/T of Gate Diameter Dm to Distance T | 1.7 |

When injection molding was performed using a molding die using an epoxy resin shown in Table 4, a pressure loss in the portion of the cold runner 1 was 4.2 MPa, and a pressure loss in the portion of the cavity 2 was 2.6 MPa. A total pressure loss was 6.8 MPa, which was sufficiently low with respect to the high-temperature tensile strength, and therefore die breakage due to plastic deformation did not occur. In addition, die breakage due to thermal deformation of the epoxy was not observed.

### Example 4

Table 5 shows material physical properties of the fixed piece 3 and the movable piece 4 in Example 4, the gate diameter Dm of the gate 10 illustrated in FIG. 1, and the ratio Dm/T of Dm to the distance T.

TABLE 5

| Material Physical | Material Name | Chemical Wood | |
|---|---|---|---|
| Properties of | Thermal Conductivity | 0.3 | W/mK |
| Fixed Piece 3 and | Density | 1.2 | g/cm³ |
| Movable Piece 4 | High-Temperature Tensile | 31 MPa | |
| | Strength (At 100° C.) | (50 MPa at Room | |
| | | Temperature) | |
| | Thermal Deformation | 190° | C. |
| | Temperature | | |

| | | |
|---|---|---|
| Volume of Molding Die | 500 | cm³ |

| | |
|---|---|
| Gate Diameter Dm of Cold Runner | Φ1.8 |
| Ratio Dm/T of Gate Diameter Dm to Distance T | 1.1 |

When injection molding was performed using a molding die using a chemical wood shown in Table 5, a pressure loss in the portion of the cold runner 1 was 13.4 MPa, and a pressure loss in the portion of the cavity 2 was 2.7 MPa. A total pressure loss was 16.1 MPa, which was sufficiently low with respect to the high-temperature tensile strength, and therefore die breakage due to plastic deformation did not occur. In addition, die breakage due to thermal deformation of the chemical wood was not observed.

### Example 5

Table 6 shows material physical properties of the fixed piece 3 and the movable piece 4 in Example 5, the gate diameter Dm of the gate 10 illustrated in FIG. 1, and the ratio Dm/T of Dm to the distance T.

TABLE 6

| Material Physical | Material Name | Ceramic | |
|---|---|---|---|
| Properties of | Thermal Conductivity | 3.0 | W/mK |
| Fixed Piece 3 and | Density | 2.5 | g/cm³ |
| Movable Piece 4 | High-Temperature Tensile | 350 MPa | |
| | Strength (At 1200° C.) | (1000 MPa at Room | |
| | | Temperature) | |
| | Thermal Deformation | 1500° | C. |
| | Temperature | | |

| | | |
|---|---|---|
| Volume of Molding Die | 500 | cm³ |

| | |
|---|---|
| Gate Diameter Dm of Cold Runner | Φ5 |
| Ratio Dm/T of Gate Diameter Dm to Distance T | 2.8 |

When injection molding was performed using a molding die using a ceramic shown in Table 6, die breakage due to plastic deformation and die breakage due to thermal deformation were not observed.

### Example 6

Table 7 shows material physical properties of the fixed piece 3 and the movable piece 4 in Example 6, the gate diameter Dm of the gate 10 illustrated in FIG. 1, and the ratio Dm/T of Dm to the distance T.

TABLE 7

| Material Physical | Material Name | Glass | |
|---|---|---|---|
| Properties of | Thermal Conductivity | 1.6 | W/mK |
| Fixed Piece 3 and | Density | 2.5 | g/cm³ |
| Movable Piece 4 | High-Temperature Tensile | 100 MPa | |
| | Strength (At 100° C.) | (300 MPa at Room | |
| | | Temperature) | |
| | Thermal Deformation | 200° | C. |
| | Temperature | | |

| | | |
|---|---|---|
| Volume of Molding Die | 500 | cm³ |

| | |
|---|---|
| Gate Diameter Dm of Cold Runner | Φ5 |
| Ratio Dm/T of Gate Diameter Dm to Distance T | 2.8 |

When injection molding was performed using a molding die using glass shown in Table 7, die breakage due to plastic deformation and die breakage due to thermal deformation were not observed.

### Comparative Example 1

Table 8 shows material physical properties of the fixed piece 3 and the movable piece 4 in Comparative Example 1, the gate diameter Dm of the gate 10 illustrated in FIG. 1, and the ratio Dm/T of Dm to the distance T. In Comparative Example 1, metal is used as the material of the fixed piece 3 and the movable piece 4.

TABLE 8

| Material Physical | Material Name | SS400 (SUS) | |
|---|---|---|---|
| Properties of | Thermal Conductivity | 20 | W/mK |
| Fixed Piece 3 and | Density | 7.8 | g/cm³ |
| Movable Piece 4 | High-Temperature Tensile | 270 MPa | |
| | Strength | (270 MPa at Room | |
| | | Temperature) | |
| | Thermal Deformation | 500° | C. |
| | Temperature | | |

| | | |
|---|---|---|
| Volume of Metal Die | 1870 | cm³ |

| | |
|---|---|
| Gate Diameter Dm of Cold Runner | Φ1.8 |
| Ratio Dm/T of Gate Diameter Dm to Distance T | 0.6 |

When injection molding was performed using a metal die using SS400 (SUS) shown in Table 8, die breakage due to plastic deformation and die breakage due to thermal deformation were not observed. A pressure loss in the portion of the cold runner 1 was 36.2 MPa, a pressure loss in the portion of the cavity 2 was 10.4 MPa, and a total pressure loss was 46.6 MPa. SS400 has a high high-temperature tensile strength and a high thermal deformation temperature, and therefore die breakage did not occur. However, since the thermal conductivity is high, the resin was easily cooled and solidified on the wall surface of the cold runner, and it was necessary to increase the injection pressure in order to ensure filling into the cavity and to increase the volume of the mold in order to withstand the high injection pressure. Since the metallic material such as SS400 has a high density, a weight of the molding die was larger than those in Examples.

### Comparative Example 2

Table 9 shows material physical properties of the fixed piece 3 and the movable piece 4 in Comparative Example 2, the gate diameter Dm of the gate 10 illustrated in FIG. 1, and the ratio Dm/T of Dm to the distance T. In Comparative Example 2, a chemical wood was used as the material of the fixed piece 3 and the movable piece 4, and the molding die is formed such that the gate diameter Dm is smaller than the distance T corresponding to a thickness of the resin molded product immediately below the gate.

TABLE 9

| Material Physical | Material Name | Chemical Wood | |
|---|---|---|---|
| Properties of | Thermal Conductivity | 0.3 | W/mK |
| Fixed Piece 3 and | Density | 1.2 | g/cm³ |
| Movable Piece 4 | High-Temperature Tensile | 31 MPa | |
| | Strength (At 100° C.) | (50 MPa at Room | |
| | | Temperature) | |
| | Thermal Deformation | 190° | C. |
| | Temperature | | |

| | | |
|---|---|---|
| Volume of Molding Die | 500 | cm³ |

| | |
|---|---|
| Gate Diameter Dm of Cold Runner | Φ1.4 |
| Ratio Dm/T of Gate Diameter Dm to Distance T | 0.8 |

When injection molding was performed using a molding die using the chemical wood shown in Table 9, a pressure loss in the portion of the cold runner 1 was 29.1 MPa, a pressure loss in the portion of the cavity 2 was 3.9 MPa, and a total pressure loss was 33.0 MPa. The molten resin collided with a portion of the movable piece 4 immediately below the gate 10 in FIG. 1 at a high flow speed, plastic deformation occurred at this portion, and durability of the molding die was significantly reduced.

As described above, in Examples 1 to 6, the molding die was manufactured using the material containing any one of the resin, the ceramic, and the glass as the main component, and a configuration satisfying the relationship of T (mm)<Dm (mm) was adopted, so that the molding dies excellent in practical characteristics were implemented.

### Modified Example

The runner-attached molded product molded by the injection molding apparatus according to the embodiment will be described with reference to a modified example. As described above, the runner-attached molded product refers to a product obtained by integrally taking out the resin molded product and the runner solidified material from the molding die.

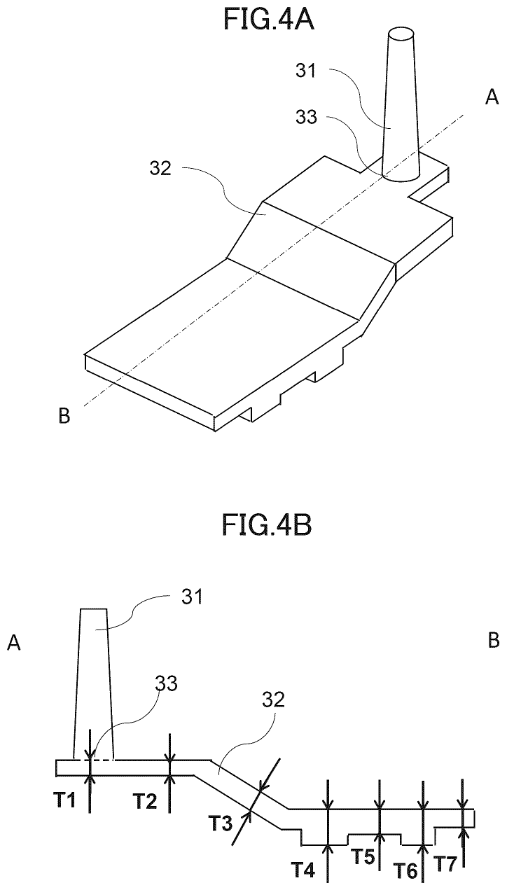

FIG. 4A is an external view illustrating an appearance of a runner-attached molded product according to the modified example when viewed obliquely from above, and FIG. 4B is a cross-sectional view of the runner-attached molded product taken along line A-B passing through the runner solidified material.

The runner-attached molded product is a resin molded product in which a resin molded product 32 and a runner solidified material 31 are integrated. In the runner-attached molded product taken out from the injection molding apparatus, the runner solidified material 31 is removed as necessary, but the resin molded product 32 may be used in a state in which the runner solidified material 31 is attached depending on the application of the resin molded product 32. Although the figures illustrate a state in which the runner solidified material is not removed, a gate mark 33 which is a trace of the gate 10 at the time of molding can remain in the resin molded product 32 even in a case where the runner solidified material 31 is removed.

In the present modified example, the molding die is also formed such that the relationship of T (mm)<Dm (mm) is satisfied, in which T (mm) represents the distance between the molding surface of the movable piece 4 that faces the gate 10 and the gate 10, and Dm (mm) represents the inner diameter of the gate 10. Furthermore, Dm may be set in consideration of not only a thickness of the cavity immediately below the gate but also an average diameter of a flow path cross section of the molten resin in the cavity. In other words, Dm can be set not only to be larger than a thickness T1 illustrated in FIG. 4B but also to be larger than an average thickness of T1 to T7.

### Modification

Note that the present disclosure is not limited to the embodiments and examples described above, and many modifications can be made within the technical idea of the present disclosure. For example, all or some of the different embodiments and examples described above may be combined and implemented.

In the above description, an example in which the movable piece and the fixed piece are formed of the same type of material has been described, but the movable piece and the fixed piece may be formed using different types of materials containing any one of the resin, the ceramic, and the glass as the main component.

According to the present disclosure, it is possible to provide a molding die using a material different from metal and having more excellent durability than a resin molding die according to the related art.

Furthermore, the contents of disclosure in the present specification include not only contents described in the present specification but also all of the items which are understandable from the present specification and the drawings accompanying the present specification. Moreover, the contents of disclosure in the present specification include a complementary set of concepts described in the present specification. Thus, if, in the present specification, there is a description indicating that, for example, “A is B”, even when a description indicating that “A is not B” is omitted, the present specification can be said to disclose a description indicating that “A is not B”. This is because, in a case where there is a description indicating that “A is B”, taking into consideration a case where “A is not B” is a premise.

### Other Embodiments

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-84071, filed May 23, 2024, which is hereby incorporated by reference herein in its entirety.

What is claimed is:

1. A molding die comprising:
a first die having a first molding surface; and
a second die having a second molding surface and a runner surface connected to the second molding surface by a connection portion,
wherein in a state in which the first die and the second die are clamped, a runner is defined by the runner surface, and a cavity is defined by the first molding surface and the second molding surface,
a material of at least a part of the first die and the second die contains any one of a resin, a ceramic, and glass as a main component, and
a relationship of T (mm)<Dm (mm) is satisfied, in which T (mm) represents a shortest distance between the connection portion and the first molding surface, and Dm (mm) represents an inner diameter of the connection portion.

2. The molding die according to claim 1, wherein in the state in which the first die and the second die are clamped, a portion within a distance D (mm) equal to Dm (mm) from the connection portion is formed of the material in the first die.

3. The molding die according to claim 1, wherein Dm satisfies a condition Dm (mm)≤5 (mm).

4. The molding die according to claim 1, wherein a relationship of Vc (mm³)<Vr (mm³) is satisfied, in which Vc (mm³) represents a volume of the cavity, and Vr (mm³) represents a volume of the runner.

5. The molding die according to claim 1, wherein
the material has a high-temperature tensile strength of 31 (MPa) or more at 100 (° C.), and/or
the material has a thermal deformation temperature of 150 (° C.) or higher.

6. The molding die according to claim 1, wherein the material has a high-temperature tensile strength of 270 (MPa) or less at 100 (° C.).

7. The molding die according to claim 1, wherein the material has a thermal deformation temperature of 500 (° C.) or lower.

8. The molding die according to claim 1, wherein the material has a density of 3.0 (g/cm³) or less.

9. The molding die according to claim 1, wherein the material has a thermal conductivity of 5.0 (W/mK) or less.

10. The molding die according to claim 1, wherein L satisfies a condition L (mm)>10 (mm), in which L (mm) represents a length of a flow path of the runner.

11. The molding die according to claim 1, wherein
a facing region of the first molding surface that faces the connection portion is formed of the material, and/or
in the first die, a portion of the first molding surface within 1 mm from a region facing the second molding surface is formed of the material, and/or
in the second die, a portion of the second molding surface within 1 mm from a region facing the first molding surface is formed of the material, and/or
in the second die, a portion within 1 mm from the runner surface is formed of the material.

12. The molding die according to claim 1, wherein the runner is a cold runner.

13. The molding die according to claim 1, wherein the first die includes a metal support member that supports a portion formed of the material.

14. The molding die according to claim 1, wherein the main component of the material is a polyimide resin.

15. The molding die according to claim 1, wherein the main component of the material is an epoxy resin.

16. A molding die comprising:
a first die having a first molding surface; and
a second die having a second molding surface and a runner surface connected to the second molding surface by a connection portion,
wherein 50 vol % or more of the molding die is formed of a material containing a polyimide resin as a main component.

17. An injection molding apparatus comprising:
the molding die according to claim 1; and
an injection unit configured to inject a molten resin into the runner.

18. The injection molding apparatus according to claim 17, wherein a relationship of Dm (mm)<Dn (mm) is satisfied, in which Dn (mm) represents a nozzle diameter of the injection unit.

19. A method for producing a resin molded product, the method comprising:
injecting, by using the injection molding apparatus according to claim 17, the molten resin from the injection unit into the runner, filling the cavity with the molten resin, and then solidifying the molten resin.

20. A method for producing a resin molded product, the method comprising:
injecting, by using an injection molding apparatus including the molding die according to claim 16 and an injection unit configured to inject a molten resin into a runner defined on the runner surface, the molten resin from the injection unit into the runner, filling a cavity defined by the first molding surface and the second molding surface with the molten resin, and then solidifying the molten resin.
